(19) United States
(12) Patent Application Publication
(10) Pub. No.: US 2014/0084678 A1
(43) Pub. Date: Mar. 27, 2014

(54) MODULAR ELECTRICAL CONNECTION DEVICE/MODULAR PLUG CONNECTOR, ELECTRICAL COMPONENT FOR SUCH A PLUG, SET OF ELECTRICAL COMPONENTS AND ELECTRIC VEHICLE USING SAID PLUG CONNECTOR

(71) Applicant: RENAULT s.a.s., Boulogne Billancourt (FR)

(72) Inventor: Sylvain ISAAC, Orgerus (FR)

(21) Appl. No.: 13/624,508

(22) Filed: Sep. 21, 2012

(51) Int. Cl. H01R 13/627

(52) U.S. Cl. CPC H01R 13/627
USPC 307/10.1; 439/701

(57) ABSTRACT

The invention relates to a modularizable electrical connection plug (100), intended to be connected to an electrical device, provided with:
a first element (110) comprising first electrical contacts (111),
a second element (120) separately comprising, on the one hand, intermediate electrical contacts (121) adapted to be connected to the said first electrical contacts (111) and, on the other hand, electrical output contacts (122) intended to be connected to electrical terminals of a current outlet,
means (140) for assembling the first and the second element together with one another.

According to the invention, the plug has interlocking means (150) for assembly of the first and second elements, distinct from the said assembly means.

### TECHNICAL FIELD TO WHICH THE INVENTION RELATES

The present invention relates generally to the field of electrical connection plugs.

More particularly, it relates to a modularizable electrical connection plug, intended to be connected to an electrical device, provided with:
a first element comprising first electrical contacts,
a second element separately comprising, on the one hand, intermediate electrical contacts adapted to be connected to the said first electrical contacts and, on the other hand, electrical output contacts intended to be connected to electrical terminals of a current outlet,
means for assembling the first and the second element together with one another.

It has a particularly advantageous application for construction of an electrical plug integrated in an electric or hybrid vehicle in order to connect its battery charger to a current outlet.

The invention also relates to an electrical element separately comprising, on the one hand, intermediate electrical contacts adapted to be connected to first electrical contacts of an electrical plug of an electrical device and, on the other hand, electrical output contacts intended to be connected to electrical terminals of a current outlet, and means for assembling this electrical element with the said plug.

It additionally relates to a set of these electrical elements and to a motor vehicle equipped with an electrical plug such as described in the foregoing.

### TECHNOLOGICAL BACKGROUND

In a certain type of electric or hybrid vehicle, the supply cord of the electrical battery for driving the vehicle is integrated therewith.

Traditionally, the free end of this cord is equipped with an electrical connection plug having electrical contacts adapted to be connected to a current outlet for supplying the battery charger.

A disadvantage of this system is that there exist numerous standards for the current outlet that the user may have to use on a trip. Thus the possibilities for recharging the vehicle battery are greatly reduced, especially when the driver travels into different countries.

The different standards in existence correspond on the one hand to the different standards in force in different countries, for example in France, Great Britain, Switzerland or Italy, and on the other hand to the different standards in force for current outlets in the private sector, for example at the user's home, and the current outlets of the public sector, accessible in public charging stations, for example.

As a rule, each current outlet standard is able to cooperate only with a single type of electrical plug. The electrical plug provided on the vehicle is therefore actually incompatible with a large number of current outlets, with which its electrical contacts cannot cooperate.

A first possibility for resolving this problem would be to use an adapter having on one hand electrical contacts adapted to cooperate with the electrical plug provided in the vehicle and on the other hand other electrical contacts adapted to cooperate with the current outlets of a standard different from that usable with the electrical plug alone.

However, this solution, which is used in fields other than that of charging motor-vehicle batteries, is not satisfactory, because the connection of the electrical plug and the adapter is not sufficiently secured. Such an electrical association for recharging batteries of electric vehicles is therefore prohibited in numerous countries.

### OBJECT OF THE INVENTION

In order to remedy the aforesaid disadvantage of the prior art, the present invention proposes a new type of secured modularizable electrical plug.

More particularly, there is proposed according to the invention an electrical plug such as described in the introduction, having interlocking means for assembly of the first and second elements, distinct from the said assembly means.

In this way, the electrical plug has an interchangeable part with which it can be adapted to different current outlet standards. In addition, the electrical connection of the two elements forming the plug is secured, in the sense that this connection is interlocked by the said interlocking means.

Other non-limitative and advantageous characteristics of the electrical plug in conformity with the invention are the following:
the said interlocking means can be deactivated only when the plug is not connected to the said current outlet;
the said interlocking means are accessible only on one connecting face of the second element, which face carries the electrical output contacts of the said plug;
the said interlocking means can be deactivated only by means of a key;
the said interlocking means are mechanical means having a movable lock adapted to be seated in the said second element and a recess made in the said first element of the plug with which the said lock is adapted to cooperate in retained relationship when the interlocking means are activated;
there are provided connection-blocking means for preventing the connection of the electrical output contacts of the plug with the said electrical outlet when the interlocking means are deactivated;
the said connection-blocking means have a means for retracting the said interlocking means to a stable position in which they form a projection on the connecting face of the said second element of the plug when these interlocking means are deactivated;
there are provided means for sealing between the said first and second elements.

The invention also relates to an electrical element separately comprising, on the one hand, intermediate electrical contacts adapted to be connected to first electrical contacts of an electrical plug of an electrical device and, on the other hand, electrical output contacts intended to be connected to electrical terminals of a current outlet, and means for assembling this electrical element together with the said plug, this electrical element having means for interlocking the assembly of this electrical element and of the said plug that are distinct from the said assembly means and are adapted to cooperate with complementary interlocking means of the said plug.

In this way this electrical element can be connected securely to an electrical plug to permit the use of this plug with a current outlet whose standard is different from the standard of the outlets usable with the plug alone.

Other non-limitative and advantageous characteristics of the electrical element in conformity with the invention are the following:
the said interlocking means can be deactivated only when the electrical element is not connected to the said current outlet;
the said interlocking means are accessible only on one connecting face of this element, which face carries the electrical output contacts;
the said interlocking means can be deactivated only by means of a key;
the said interlocking means are mechanical means having a movable lock seated in the said element and adapted to cooperate in retained relationship with a recess made in the plug;
there are provided connection-blocking means for preventing the connection of the electrical output contacts of the plug with the said electrical outlet when the interlocking means are deactivated;
the said connection-blocking means have a means for retracting the said interlocking means to a stable position in which they form a projection on the connecting face of the said element when these interlocking means are deactivated;
there are provided sealing means adapted to establish a sealed connection of the intermediate electrical contacts of the electrical element and the first electrical contacts of the electrical plug.

The invention also relates to a set of electrical elements comprising a plurality of elements such as described in the foregoing, at least two of these electrical elements having different output contacts.

Finally, the invention relates to an electric motor vehicle having an electrical battery connected to a supply cable for recharging it, the end of the said cable having an electrical plug such as described in the foregoing. More precisely, it relates in particular to an electric motor vehicle having an electrical battery connected for its recharging to a charger of this battery, wherein the charger is connected to a supply cable whose end is equipped with the said electrical plug.

### DETAILED DESCRIPTION OF AN EXEMPLARY EMBODIMENT

From the description hereinafter with reference to the attached drawings, given by way of non-limitative examples, what the invention consists of and how it may be implemented will be clearly understood.

In the attached drawings:

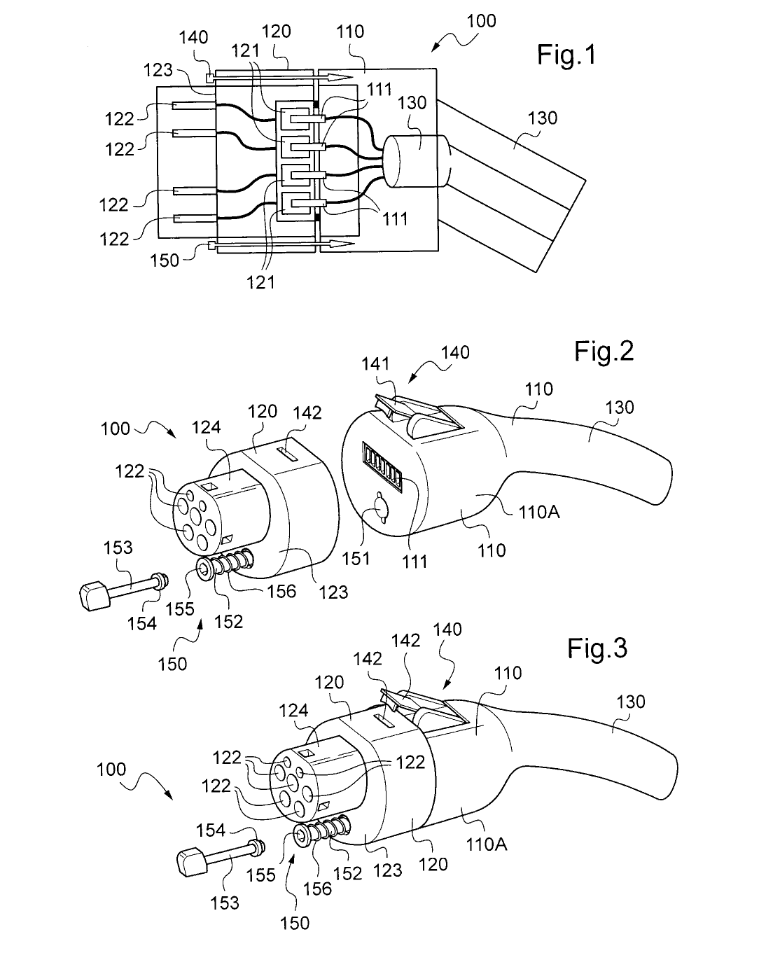

FIG. 1 is a schematic view of the electrical connection plug according to the invention,

FIG. 2 is an exploded view of a first embodiment of the electrical plug according to the invention,

FIG. 3 is an assembled view of the embodiment of the electrical plug of FIG. 2, when the interlocking means are deactivated,

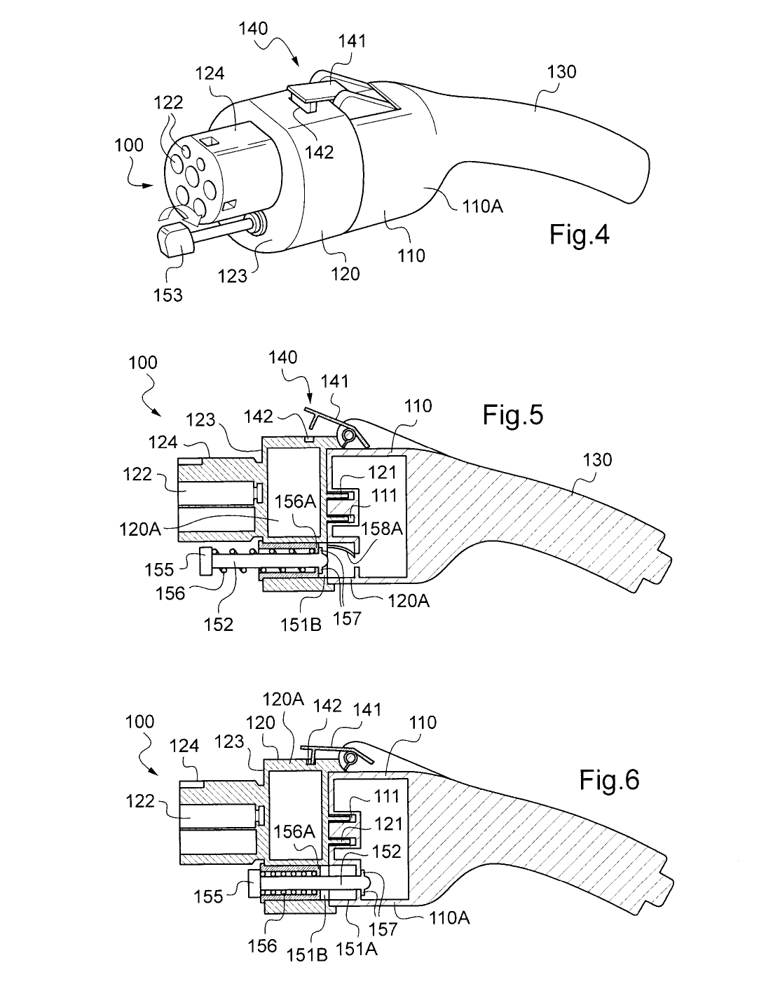

FIG. 4 is a view similar to that of FIG. 3, when the interlocking means are activated,

FIG. 5 is a cross-sectional view of the electrical plug of FIG. 3,

FIG. 6 is a cross-sectional view of the electrical plug of FIG. 4,

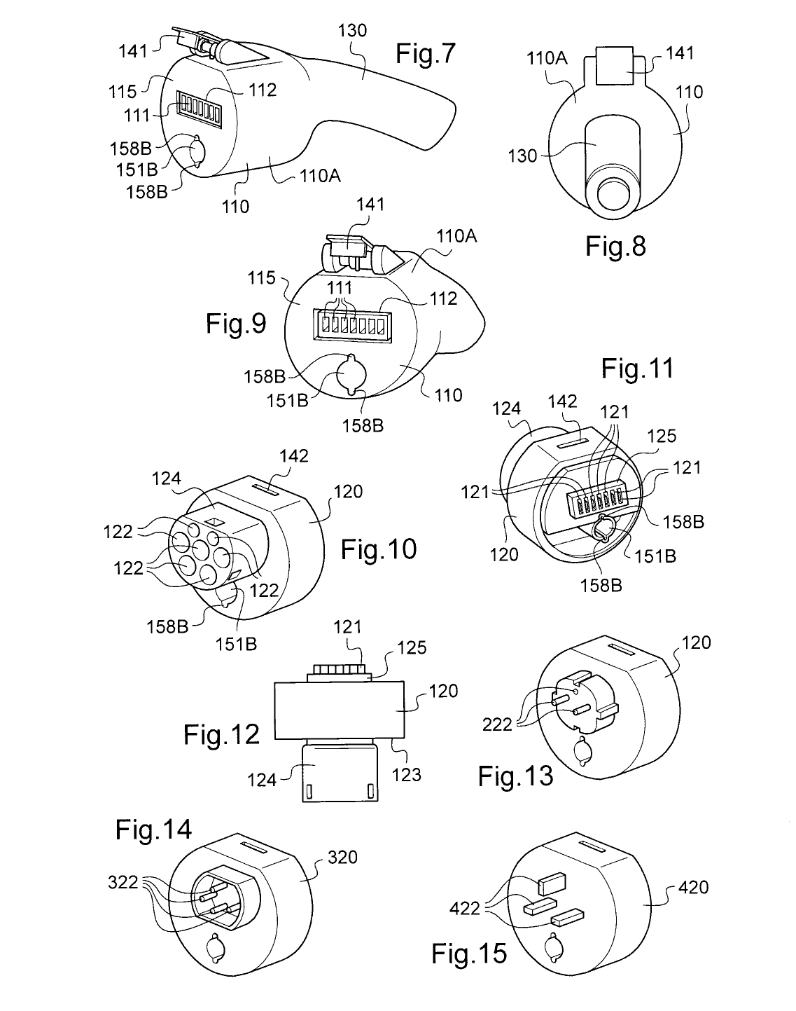

FIG. 7 is a perspective view of a first element of the plug of FIGS. 2 to 6,

FIG. 8 is a rear view of the first element of FIG. 7,

FIG. 9 is an enlarged perspective view of the first element of FIG. 7,

FIG. 10 is a front perspective view of a second element of the electrical plug of FIGS. 2 to 6,

FIG. 11 is a rear perspective view of the second element of FIG. 10,

FIG. 12 is a view from below of the second element of FIG. 10,

FIGS. 13 to 15 are front perspective views of different embodiments of the second element of the plug of FIG. 10.

In FIG. 1 there is schematically represented a connection plug 100 according to the invention.

This electrical connection plug 100 is intended to be connected to an electrical device, for example to a charger of the battery for driving an electric or hybrid vehicle used for electrical recharging of this battery.

It is provided with a first element 110 comprising first electrical contacts 111 and a second element 120 separately comprising, on the one hand, intermediate electrical contacts 121 adapted to be connected to the said first electrical contacts 111 and, on the other hand, electrical output contacts 122 intended to be connected to electrical terminals of a current outlet (not represented).

First electrical contacts 111 of first element 110 are adapted to be connected, on the one hand, to the said electrical device to be supplied and, on the other hand, to the said intermediate electrical contacts of second element 120.

In the present case, first electrical contacts 111 of first element 110 are connected to an electrical cable 130 connected to the electrical device.

Intermediate electrical contacts 121 of second element 120 are adapted to cooperate with first electrical contacts 111 of first element 110 in order to connect second element 120 and first element 110 electrically.

Intermediate electrical contacts 121 of second element 120 are also connected electrically to output contacts 122 in the interior of second element 120.

Connection plug 100 according to the invention also comprises means, represented schematically by arrow 140 in FIG. 1, for assembling first and second elements 110, 120 together with one another.

These assembly means 140 are, for example, nesting means, clip-fixing means or means functioning by slide action or by screwing. Any assembly means known to the person skilled in the art may be envisioned.

It is noteworthy that connection plug 100 is additionally provided with means 150, separate from said assembly means 140, for interlocking the assembly of first and second elements 110, 120, which means are represented schematically in FIG. 1 by arrow 150.

These interlocking means make it possible to block the assembly of the first and second elements and to prevent separation and therefore electrical disconnection of these two elements by unauthorized persons or by an accidental maneuver.

Interlocking means 150 may be placed in two states: a state in which they are deactivated and permit separation of the two elements of connection plug 100, and a state in which they are activated and block such separation.

Preferably, first electrical contacts 111 of first element of connection plug 110 are not adapted to cooperate with any one of the existing current outlets. Thus first electrical contacts 111 are uniquely adapted to cooperate with intermediate electrical contacts 121 of second element 120 of connection plug 100.

Thus first element 110 of connection plug 100 is preferably unusable alone as an electrical connection plug.

A first possible embodiment of the connection plug according to the invention is represented in FIGS. 2 to 12.

The reference numerals of FIG. 1 have been retained for the corresponding elements of this embodiment.

As represented in these FIGS. 2 to 12, connection plug 100 has a median part having overall cylindrical shape. At one of these longitudinal ends, this median part has a connection face 123, which carries electrical output contacts 122 of plug 100. The other end of this median part is connected to an envelope of supply cable 130.

This first element 110 has an overall cylindrical hollow body 110A represented in FIGS. 2 to 9. In the present case, this body 110A is prolonged on one side by the envelope of the supply cable (see FIGS. 5 and 6). In the present case, first element 110 is formed in one piece with the envelope of supply cable 130.

Supply cable 130 penetrates into the interior of body 110A of first element 110, to be connected electrically to first electrical contacts 111.

This electrical connection of cable 130 to first electrical contacts 111 of this first element 110 is not represented in FIGS. 5 and 6.

In the present case, first electrical contacts 111 are disposed on a mounting face 115 of first element 110 opposite the entry of supply cable 130, more particularly visible in FIGS. 7 and 9.

In the present case, first electrical contacts 111 are contacts of the female terminal type. Thus they are situated in recesses of mounting face 115.

A groove 112 is provided in mounting face 115 and surrounds all of first electrical contacts 111. This groove 112 receives a rib 125 (FIGS. 11 and 12) of second element 120 of plug 100.

The nesting of rib 125 in groove 112 contributes to the assembly of the two elements of the connection plug. In the present case groove 125 and groove 112 are therefore part of means 140 for assembling these two elements together with one another.

Second element 120 has an overall cylindrical hollow body 120A (FIGS. 5 and 6) that is adapted to the dimensions of body 110A of first element 110. One of the longitudinal faces of this body 120A is intended to be oriented toward mounting face 115 of first element 110. This face is opposite connection face 123 carrying electrical output contacts 122 of plug 100. It carries intermediate electrical contacts 121. In the present case, these intermediate electrical contacts 121 are of the male type and are adapted to be plugged into first electrical contacts 111 of female type of first element 110.

Intermediate electrical contacts 121 are surrounded by rib 125, which is adapted to cooperate with groove 112 of mounting face 115 of first element 110.

In the embodiment represented in FIGS. 2 to 12, output electrical contacts 122 conform with the standard known as “type II”, which is adapted to cooperate with the current outlets available in the public sector in Germany.

These electrical output contacts 122 comprise seven well-like cavities made in a block 124 projecting from connection face 123 of second element 120.

As a variant, the electrical output contacts of the plug may have any geometries capable of being suitable for connection of the plug to a current outlet of any standard whatsoever.

In particular, in FIGS. 13 to 15, there are represented three other embodiments of electrical output contacts 222, 322, 422 that may be disposed on the connection face of second element 220, 320, 420 of the connection plug according to the invention.

FIG. 13 shows electrical output contacts 222 of a second embodiment of the electrical plug adapted to cooperate with the current outlets available, for example, in the domicile of the users, in the private sector, in France and in Germany.

FIG. 14 shows electrical output contacts 322 of a third embodiment of the electrical plug adapted to cooperate with the current outlets available, for example, in the public sector in Italy. This type of electrical output contacts corresponds to type III-A.

FIG. 15 shows electrical output contacts 422 of a fourth embodiment of the electrical plug adapted to cooperate with the current outlets available, for example, in the domicile of the users, in the private sector, in Great Britain.

Aside from the differences in geometry and electrical circuit imposed by the different standards on output contacts 222, 322, 422, second element 220, 320, 420 corresponding to these different embodiments is identical to second element 120 described in the foregoing and in the following.

As represented in FIGS. 2 to 6, means 140 for assembling the two elements 110, 120 of the plug also have, in the present case, a clip 141 carried by first element 110 and a slot 142 made in the lateral wall of body 120A of second element 120, with which clip 141 is adapted to cooperate in retained relationship.

Clip 141 is, for example, equipped at its free end with a hook adapted to catch onto a shoulder of slot 142. Clip 141 is mounted to pivot on the lateral wall of body 110A of first element 110.

Interlocking means 150 of electrical plug 100 represented in FIGS. 2 to 6 are, for example, mechanical means provided with a movable lock seated in said second element 120 and a recess, made in the said first element of the plug, with which the said lock is adapted to cooperate in retained relationship when it is activated.

More precisely, the movable lock in the present case has the form of a cylindrical rod 152 (FIGS. 2 to 6), equipped at one of its ends with two diametrically opposite studs 157 (FIGS. 5 and 6) and at the other end with a head containing a socket-like cavity 155.

Interlocking means 150 also have two seats: a first seat 151A made in first element 110 of plug 100 and a second seat 151B made in second element 120, so that rod 142 can be received over its entire length in the two seats 151A, 151B placed end-to-end.

First seat 151A is open toward mounting face 110A of first element 110. This first seat has dimensions adapted except for a small clearance to the lateral dimensions of rod 142. A helicoidal groove 158A (FIG. 5) is provided in the internal face of this first seat 151A to receive each stud 157 of rod 152.

Second seat 151B traverses first element 110. This second seat has dimensions adapted except for a small clearance to the lateral dimensions of rod 142. A straight groove (FIGS. 7 and 9) is provided in the internal face of this second seat 151B to receive each stud 157 of rod 152.

These interlocking means 150 function as a bayonet-lock system: once the two elements of plug 100 have been assembled by virtue of assembly means 140, rod 152 is introduced into second seat 151B. Studs 157 slide in straight grooves 158B. Rod 152 is then introduced into first seat 151A. Studs 157 slide in helicoidal grooves 158B, thus imposing a turning movement on rod 152. Studs 157 pass a hard point and are blocked in second element 120. The turning movement corresponds, for example, to one quarter turn.

At precisely this moment the rod is entirely embedded in seats 151A, 151B, and its head is accessible on connection face 123 of the second element, as represented in FIG. 4.

Interlocking means 150 are then in their activated state and the assembly of the two elements of plug 100 is then interlocked.

To remove the screw of the two seats of the plug and thus to deactivate interlocking means 150, it is necessary on the one hand to have access to the head of rod 152 and on the other hand to use a key 153 (FIGS. 2 to 4), the end of which is adapted to cooperate with socket-like cavity 155 of the head of rod 152.

Since connection face 123 of electrical plug 100 is pressed against the current outlet when plug 100 is plugged into the outlet, for example during charging of the vehicle battery, the head of rod 152 is not accessible during charging of this battery. Thus interlocking means 150 can be deactivated only when connection plug 100 is not connected to the said current outlet.

This makes it possible to ensure reinforced electrical safety of connection plug 100 according to the invention.

In fact, this ensures that the two elements of connection plug 100 cannot be separated when the plug is connected to a current outlet.

In addition, the use of a specific key guarantees that interlocking means 150 can be deactivated only by the person possessing the key.

In addition, in the case of use of connection plug 100 for charging the battery of an electric vehicle, there are provided, in known manner, means that prevent disconnection of the connection plug and of the electrical outlet during charging of the battery. These means preventing disconnection act in the present case on second element 120 of connection plug 100. They comprise, for example, radial blocking fingers that are introduced into complementary orifices of block 124.

The means preventing disconnection must be deactivated by the driver from an electronic control unit connected to the current outlet.

The connection of the second element of connection plug 100 in the electrical outlet is therefore additionally secured.

Thus it is necessary to deactivate on the one hand the means that prevent disconnection of the plug and on the other hand the interlocking means of plug 100, before it is possible to separate the two electrical elements of plug 100.

Preferably there will be used interlocking means 150 such as described in the present case, which not only are accessible only at the front face but also can be deactivated only by virtue of a key. As a variant, however, it is possible to envision using interlocking means that exhibit only one of these characteristics.

Preferably there are also provided connection-blocking means for preventing connection of electrical output contacts 122 of connection plug 100 with the said electrical outlet when interlocking means 150 are deactivated.

In the present case, these means for blocking the connection have the form of a means 156 for retracting the said interlocking means 150 to a stable position, in which they form a projection on connection face 123 of said second element 120 of plug 100 when these interlocking means are deactivated.

The presence of this projection prevents the user from plugging the electrical plug into the current outlet when the interlocking means are deactivated. This ensures that the plug is secured during its use.

More precisely, as represented in FIGS. 5 and 6, these connection-blocking means are provided in the present case with a spring 156 coiled around rod 152 and abutting against a stop element 156A inside second seat 151B.

Rod 152 is then partly seated permanently in second seat 151B of second element 120 and in this way is captive.

This spring 156 has a stable extended position (FIG. 5). The force of this spring 156 is such that it is very difficult, even impossible, to embed rod 152 in seats 151A, 151B when interlocking means 150 are deactivated. It may also be provided that this force is such that, if the plug together with the deactivated interlocking means is plugged into the current outlet by the user, this plug is ejected from the outlet when the user releases it.

In this way, any use of connection plug 100 according to the invention when interlocking means 150 are deactivated is prevented.

Advantageously, there are additionally provided sealing means between the said first and second elements.

In the present case, these sealing means are provided with a seal disposed on the said second element 120, so as to surround the said intermediate electrical contacts 121.

More precisely, in the present case it is a rubber seal disposed on rib 125 surrounding intermediate electrical contacts 121.

This seal makes it possible to prevent infiltration of water or dust, which could degrade the electrical connection between the first and the second element or could cause a short circuit.

By virtue of connection plug 100 according to the invention, second element 120 carrying electrical output contacts 122 may be changed quickly and easily.

For this purpose, it is sufficient for disconnecting plug 100 from the outlet into which it is plugged, if such is the case, to introduce the key into socket-like cavity 155 of the head of rod 1522 and to impose an adequate turning movement of rod 152.

Studs 157 of rod 152 then pass back over the hard point and slide in grooves 158A of the first seat. Interlocking means 150 are then in their deactivated state.

Second element 120 may then be separated from the first by unclipping clip 141 and extracting rib 125 from complementary groove 112.

The user then quickly and easily assembles a second electrical element having different electrical output contacts adapted to the outlet that he wishes to use.

The connection-blocking means prevent the user from forgetting to activate interlocking means 150.

In this way the user is able to keep in his vehicle a set of second elements 120 having different electrical output contacts and to choose the second element to be assembled with the first element in accordance with the standard of the current outlet available for charging the vehicle.

This set advantageously takes up little space.

In this way the user is able to recharge his vehicle with different types of current outlet in complete safety.

1. A modularizable electrical connection plug (100), intended to be connected to an electrical device, provided with:
a first element (110) comprising first electrical contacts (111),
a second element (120) separately comprising, on the one hand, intermediate electrical contacts (121) adapted to be connected to the said first electrical contacts (111) and, on the other hand, electrical output contacts (122) intended to be connected to electrical terminals of a current outlet,
means (140) for assembling the first (110) and the second element (120) together with one another,
characterized in that it has interlocking means (150) for assembly of the first (110) and second elements (120), distinct from the said assembly means (140).

2. A modularizable electrical connection plug (100) according to claim 1, wherein the said interlocking means (150) can be deactivated only when the connection plug (100) is not connected to the said current outlet.

3. A modularizable electrical connection plug (100) according to one of claims 1 and 2, wherein the said interlocking means (150) are accessible only on one connecting face (123) of the second element (120) which carries the electrical output contacts (122) of the said plug (100).

4. A modularizable electrical connection plug (100) according to one of the preceding claims, wherein the said interlocking means (150) can be deactivated only by means of a key (153).

5. A modularizable electrical connection plug (100) according to one of the preceding claims, wherein the said interlocking means (150) are mechanical means having a movable lock (152) adapted to be partly seated in the said second element (120) and a recess (151A) made in the said first element (110) of the plug with which the said lock (152) is adapted to cooperate in retained relationship when the interlocking means (150) are activated.

6. A modularizable electrical connection plug (100) according to one of the preceding claims, wherein there are provided connection-blocking means (156) for preventing the connection of the electrical output contacts (122) of the plug (100) with the said electrical outlet when the interlocking means (150) are deactivated.

7. A modularizable electrical connection plug (100) according to the preceding claim, wherein the said connection-blocking means (156) have a means for retracting the said interlocking means (150) to a stable position in which these interlocking means (150) form a projection on the connecting face (123) of the said second element (120) of the plug (100) when these interlocking means (150) are deactivated.

8. A modularizable electrical connection plug (100) according to one of the preceding claims, wherein there are provided means for sealing between the said first (110) and second elements (120).

9. A modularizable electrical connection plug (100) according to the preceding claim, wherein the said sealing means are provided with a seal disposed on the said second element (120), so as to surround the said intermediate electrical contacts (121).

10. An electrical element (120) separately comprising, on the one hand, intermediate electrical contacts (121) adapted to be connected to the first electrical contacts (111) of an electrical plug of an electrical device and, on the other hand, electrical output contacts (122) intended to be connected to electrical terminals of a current outlet, and means (125, 142) for assembling this electrical element (120) together with the said plug,
characterized in that it has means (152, 151B) for interlocking the assembly of this electrical element (120) and of the said plug that are distinct from the said assembly means (125, 142), adapted to cooperate with complementary interlocking means (151A) of the said plug.

11. An electrical element according to claim 10, wherein the said interlocking means (152, 151B) can be deactivated only when the electrical element (120) is not connected to the said current outlet

12. An electrical element according to one of claims 10 and 11, wherein the said interlocking means (152, 151B) are accessible only on one connecting face (123) of this electrical element (120) which carries the electrical output contacts (122).

13. An electrical element according to one of claims 10 to 12, wherein the said interlocking means (150) can be deactivated only by means of a key (153).

14. An electrical element according to one of claims 10 to 13, wherein the said interlocking means (150) are mechanical means having a movable lock (152) adapted to be partly seated in the said electrical element (120) and adapted to cooperate in retained relationship with a recess (151B) made in the plug.

15. An electrical element according to one of claims 10 to 14, wherein there are provided connection-blocking means (156) for preventing the connection of the electrical output contacts (122) of the plug with the said electrical outlet when the interlocking means (150) are deactivated.

16. An electrical element according to the preceding claim, wherein the said connection-blocking means (156) have a means for retracting the said interlocking means (150) to a stable position in which the said interlocking means (150) form a projection on the connecting face (123) of the said element when these interlocking means (150) are deactivated.

17. An electrical element according to one of claims 10 to 16, wherein there are provided sealing means adapted to establish a sealed connection of the intermediate electrical contacts (121) of the electrical element (120) and the first electrical contacts (111) of the electrical plug.

18. A set of electrical elements comprising a plurality of electrical elements according to one of claims 10 to 17, at least two of these electrical elements having different output contacts.

19. An electric motor vehicle having an electrical battery connected to a supply cable for recharging it, the end of the said cable having an electrical plug according to one of claims 1 to 9.
